(19) United States
(12) Patent Application Publication
(10) Pub. No.: US 2016/0341645 A1
(43) Pub. Date: Nov. 24, 2016

(54) INLINE MULTIPHASE DENSITOMETER

(71) Applicant: Medeng Research Institute Ltd., Calgary (CA)

(72) Inventor: Willow Zhu Liu, Calgary (CA)

(21) Appl. No.: 14/716,370

(22) Filed: May 19, 2015

(51) Int. Cl. G01N 9/24; G01N 9/26

(52) U.S. Cl. CPC G01N 9/24; G01N 9/26

(57) ABSTRACT

An inline multiphase densitometer. This disclosure is related to an in-line device that measures the density and phase fraction of a multiphase fluid composed of three separate phases in a mixture, typically gas, water and oil, or alternatively, gas, gas condensate and water. The device is connected to a flow line and captures dynamically a sample of the fluid mix and provides a highly accurate measurement of total mixture density, Gas Volume Fraction (GVF), and liquids mixture only density from which the Water Cut (WC) is derived. The principal measurands of the device are phase fractions GVF and WC.

### FIELD

The present disclosure relates generally to in-line multiphase fluid property measurement. More particularly, the present disclosure relates to in-line measurement of fluid density and phase fraction for a multiphase fluid.

### BACKGROUND

Many oil and gas operations, chemical processes, refining processes, and fluid conveying systems involve multiphase fluids, and the density of the component phases may be useful for measurement, control operations, and other uses.

It is, therefore, desirable to provide an improved inline multiphase densitometer.

### SUMMARY

It is an object of the present disclosure to obviate or mitigate at least one disadvantage of previous densitometers.

In a first aspect, the present disclosure provides a An inline densitometer for determining one or more phase property of a multiphase fluid in a flow line, including a vertical chamber adapted to connect to the flow line by an inlet proximate a lower end of the chamber and an outlet proximate an upper end of the chamber, wherein the chamber may be isolated from the flow line by an inlet isolation valve and an outlet isolation valve, a differential pressure transducer adapted to measure, at frequent intervals or continuously, a differential pressure dp between an upper pressure tap and a lower pressure tap, separated by a gauge height H_{T} to express the transient evolution of the fluids in the chamber to produce a curve adapted to determine a minimum differential pressure dpₘᵢₙ, and a stabilized differential pressure dp_{∞}, an ultrasound Doppler level transmitter which signals are used to monitor the transient evolution of the fluids from a dynamic to static state and measure a stabilized liquid level H_{L} in the chamber, and a computer coupled with the differential pressure transducer and the ultrasound Doppler transmitter to compute the one or more phase property.

In an embodiment disclosed, the chamber is a cylinder.

In an embodiment disclosed, the differential pressure transducer comprises an inlet pressure transducer to measure an inlet pressure, an outlet pressure transducer to measure an outlet pressure, and the computer is adapted to compute the differential pressure dp by subtracting the outlet pressure from the inlet pressure.

In an embodiment disclosed the one or more phase property comprises a Gas/Liquid Mixture Density, according to the formula:

$${ρ}_{lg} = \frac{d {p}_{min}}{g \cdot {H}_{T}}$$

where ρ_{lg} is the density of the multiphase mixture that is composed of liquid and gas, dpₘᵢₙ is the minimum value of differential pressure, g is the gravitational acceleration, and H_{T} is the distance between the two pressure taps of the pressure differential sensor.

In an embodiment disclosed, the densitometer is adapted to determine a Ratio Coefficient n, according to the formula:

$$n = \frac{{H}_{L}}{{H}_{T}}$$

where n is the Ratio Coefficient, H_{L} is the Liquid Level, and H_{T} is the gauge height.

In an embodiment disclosed, the one or more phase property comprises liquid density, according to the formula:

$${ρ}_{L} = \frac{{dp}_{∞}}{g \cdot {H}_{L}}$$

where ρ_{L} is the liquid density, dp_{∞} is the stabilized differential pressure, g is the gravitational acceleration, and H_{L} is the liquid level in the chamber.

In an embodiment disclosed, the one or more phase property comprises liquid density, according to the formula:

$${ρ}_{L} = \frac{{dp}_{∞}}{n \cdot {H}_{T}}$$

where ρ_{L} is the liquid density, dp_{∞} is the stabilized differential pressure, n is the ratio coefficient, and H_{T} is the gauge height.

In an embodiment disclosed, the one or more phase property comprises Gas Volume Fraction, according to:

$$GVF = \frac{{dp}_{∞} - {dp}_{min} \cdot n}{{dp}_{∞} - {ρ}_{g} \cdot n \cdot g \cdot {H}_{T}}$$

where GVF is the Gas Volume Fraction, dpₘᵢₙ is the minimum differential pressure, n is the ratio coefficient, dp_{∞} is the stabilized differential pressure, ρ_{g} is the gas density, g is the gravitational constant, and H_{T} is the gauge height.

In an embodiment disclosed, the one or more phase property comprises Water Cut, according to:

$$WC = \frac{{dp}_{∞} - n \cdot {dp}_{o}}{n \cdot {dp}_{w} - n \cdot {dp}_{o}}$$

where WC is the water cut, dp_{∞}, is the stabilized differential pressure, n is the ratio coefficient, dpₒ is the differential pressure value when the chamber is completely filled with pure oil, and dp_{w} differential pressure value when the chamber is completely filled with pure water.

In further aspect, the present disclosure provides a method of determining one or more phase property of a multiphase fluid in a flow line, including flowing the multiphase fluid upward though a vertical chamber, capturing a sample, while, at frequent intervals or continuously, monitoring differential pressure dp across the chamber to obtain a minimum differential pressure dpₘᵢₙ and a stabilized differential pressure dp_{∞}, across a gauge height H_{T}, measuring a stabilized liquid level H_{L} in the chamber using a Doppler level transmitter, and calculating, with a computer, the one or more phase property.

In an embodiment disclosed the one or more phase property comprises a Gas/Liquid Mixture Density ρ_{lg}, according to:

$${ρ}_{lg} = \frac{{dp}_{min}}{g \cdot {H}_{T}}$$

where ρ_{lg} is the density of the multiphase mixture that is composed of liquid and gas, dpₘᵢₙ is the minimum differential pressure, g is the gravitational acceleration, and H_{T} is the gauge height.

In an embodiment disclosed, the method further includes collecting a sample of the multiphase fluid, allowing gas and any volatile components to evolve from the sample at standard conditions to provide a dead liquid sample, reintroducing the dead liquid sample into the chamber to fill the chamber to obtain a pressure differential value when the chamber is completely filled with liquid dp_{L}.

In an embodiment disclosed, the one or more phase property comprises a liquid density ρ_{L}, according to:

$${ρ}_{L} = \frac{{dp}_{L}}{g \cdot {H}_{T}}$$

where ρ_{L} is the liquid density, dp_{L} is the differential pressure value when the chamber is completely filled with liquid, g is the gravitational acceleration, and H_{T} is the gauge height.

In an embodiment disclosed, the one or more phase property comprises a Ratio Coefficient n, according to:

$$n = \frac{{dp}_{∞}}{{dp}_{L}}$$

where n is the ratio coefficient, dp_{∞} is the stabilized differential pressure, and dp_{L} is the differential pressure value when the chamber is completely filled with liquid.

In an embodiment disclosed, the one or more phase property comprises a liquid density ρ_{L}, according to the formula:

$${ρ}_{L} = \frac{{dp}_{∞}}{n \cdot g \cdot {H}_{T}}$$

where ρ_{L} is the liquid density, dp_{∞} is the stabilized differential pressure, n is the ratio coefficient, g is the gravitational acceleration, and H_{T} is the gauge height.

In an embodiment disclosed, the one or more phase property comprises a Ratio Coefficient n, according to:

$$n = \frac{{H}_{L}}{{H}_{T}}$$

where n is the ratio coefficient, H_{L} is the stabilized liquid level, and H_{T} is the gauge height.

In an embodiment disclosed, the one or more phase property comprises a Gas Volume Fraction, according to:

$$GVF = \frac{{dp}_{∞} - {dp}_{min} \cdot n}{{dp}_{∞} - {ρ}_{g} \cdot n \cdot g \cdot {H}_{T}}$$

where GVF is the Gas Volume Fraction, dpₘᵢₙ is the minimum differential pressure, n is the ratio coefficient, dp_{∞} is the stabilized differential pressure, ρ_{g} is the gas density, g is the gravitational constant, and H_{T} is the gauge height.

In an embodiment disclosed, the method further includes, separate from measuring the multiphase fluid, filling the chamber with a pure oil component of the multiphase fluid to determine a pure oil differential pressure dpₒ.

In an embodiment disclosed, the method further includes, separate from measuring the multiphase fluid differential pressure, filling the chamber with a pure water component of the multiphase fluid to determine a pure water differential pressure dp_{w}.

In an embodiment disclosed, the one or more phase property comprises Water Cut, according to:

$$WC = \frac{{dp}_{∞} - n \cdot {dp}_{o}}{n \cdot {dp}_{w} - n \cdot {dp}_{o}}$$

where WC is the water cut, dp_{∞} is the stabilized differential pressure, n is the ratio coefficient, dpₒ is the pure oil differential pressure, and dp_{w} is the pure water differential pressure.

In an embodiment disclosed, the multiphase fluid is substantially oil, water, and gas.

In an embodiment disclosed, the multiphase fluid is substantially gas, gas condensate, and water.

In an embodiment disclosed, the multiphase fluid comprising two phases or three phases.

In an embodiment disclosed, computer readable medium, has stored thereon computer instructions to perform the methods disclosed.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a simplified schematic of a densitometer of the present disclosure;

FIG. 2 is a more detailed schematic of the densitometer of FIG. 1; and

FIG. 3 is a graph of measured differential pressure dp of a densitometer of the present disclosure.

### DETAILED DESCRIPTION

Generally, the present disclosure provides a method and apparatus for multiphase fluid measurement.

This disclosure is related to flow metering instrumentation. It can be used as a standalone device to measure mixture and multiphase densities from a flow line or it can be used in conjunction with other metering devices. One such use would be to provide density measurements as live inputs to a mass flow meter. The disclosed densitometer is described as handling a multiphase fluid comprising three phases, such as oil, water and gas, or alternatively gas, gas condensate and water, however the disclosed densitometer is equally applicable to a two phase situation composed of any given combination of two separate phases. This may include two phases, such as oil/water, liquid/gas etc.

This disclosure is related to an inline device that provides the density and phase fraction of a multiphase fluid composed of three separate phases in a mixture, typically gas, water and oil, or alternatively, gas, gas condensate and water.

The device is connected to a flow line and captures dynamically a sample of the multiphase fluid mix and provides a measurement of total mixture density (ρ_{lg}), Gas

Volume Fraction (GVF), and liquids mixture only density (ρ_{L}), from which the Water Cut (WC) is derived. The principal measurands of the device are phase fractions GVF and WC.

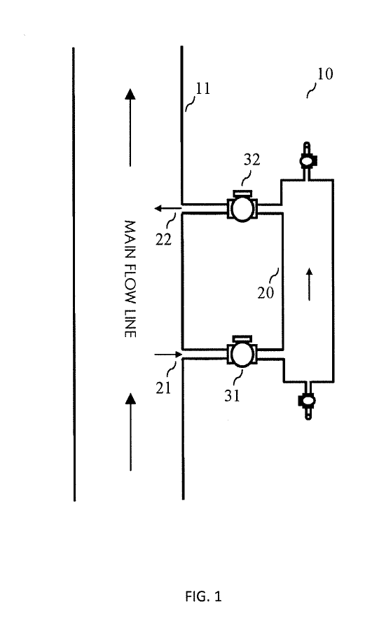

FIG. 1 is a schematic diagram of an embodiment densitometer 10 of the present disclosure where it is attached to a flow line 11. It consist mainly of a vertical cylinder 20 connected to the flow line 11 through inlet 21 and outlet 22, which respectively can be closed or opened using inlet isolation valve 31 and outlet isolation valve 32. In this embodiment, the multiphase densitometer is attached to and connected to a main flow line 11 acting as a source of multiphase fluid. In the main flow line 11, the multiphase fluid travels upward. The multiphase densitometer 10 consists of a straight cylinder 20 sealed at both ends. Relative to the cylinder 20, an inlet 21 equipped with an inlet isolation valve 31 and an outlet 22 equipped with an outlet isolation valve 32 which allow for some (or all) of the fluid from the main flow line 11 to be diverted into the multiphase densitometer 10. When valves 31 and 32 are in an open position, this flow occurs continuously and freely as a result flow of splitting from the main flow line 11. It is noted that other technical means of diverting the fluid from the main flow line 11 in any given portion can be used without altering the method or the principle of this disclosure.

The fluid in flow line 11 comprising three phases (e.g. oil, water and gas) initially flows through the straight cylinder 20 as it freely enters through inlet 21 and exits through outlet 22. However, when the valves 31 and 32 are closed simultaneously, the straight cylinder 20 becomes an isolation vessel that entraps the fluid from the main flow line 11, thus holding under same the same pressure and temperature conditions what can be described as a sample of the multiphase fluid. This sampling of the fluid is thus held as flow continues uninterrupted in the main flow line 11.

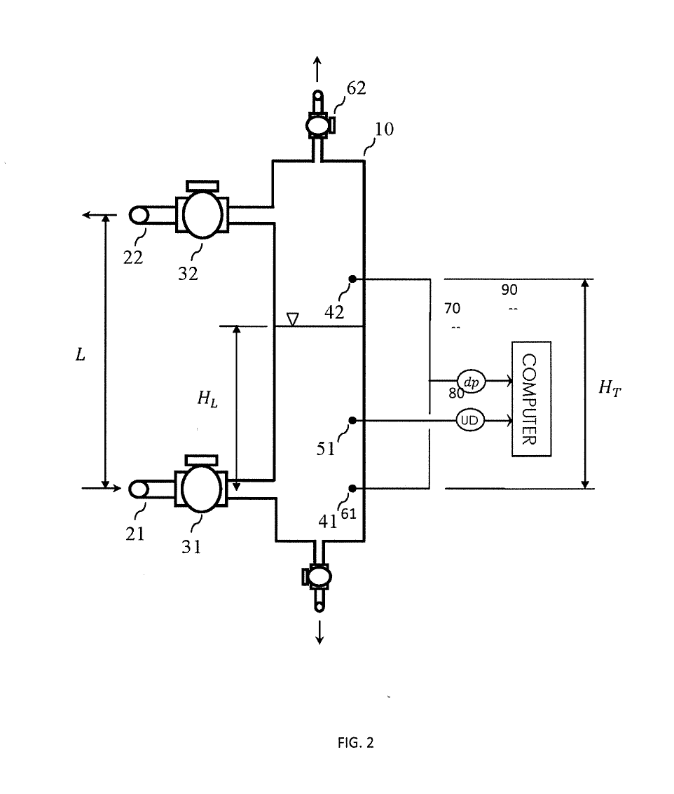

FIG. 2 is a schematic diagram depicting further the embodiment of the present disclosure with additional instrumentation. It includes a pressure differential transmitter 70 that measures a pressure differential dp across two points, upper pressure tap 41 and lower pressure tap 42 set along the height of the straight cylinder. The distance between upper pressure tap 41 and lower pressure tap 42 is defined as a gauge height H_{T}. The densitometer 10 also includes an ultrasound Doppler 80. The Doppler serves two functions. One to monitor the transient separation process of the gas phase from liquid; and the other being to detect the liquid level within the densitometer cylinder. The Doppler transmitter 80 is set along a single point 51 which location is determined to be within the lower half of the straight cylinder 20 and between points 41 and 42.

While depicted as a pressure differential transmitter 70, the pressure differential transmitter 70 may comprise a lower pressure transducer associated with the point 41 and an upper pressure transducer associated with the port 42, and the differential pressure determined by the difference, for example using the computer 90.

The straight cylinder 20 is also equipped with a drain 61 and a vent 62 at the bottom and top respectively.

The two sensors, the pressure differential transmitter 70 and the ultrasound Doppler 80, are connected to a single chip computer 90 which receives and processes the signals.

When the valves 31 and 32 are open and the multiphase fluid is flowing freely through the straight cylinder 20, the densitometer 10 is on stand-by. To begin the operation of the densitometer 10, the valves 31 and 32 are closed simultaneously and the signals from the pressure differential transmitter 70 and the ultrasound Doppler are recorded and are processed immediately with the computer 90.

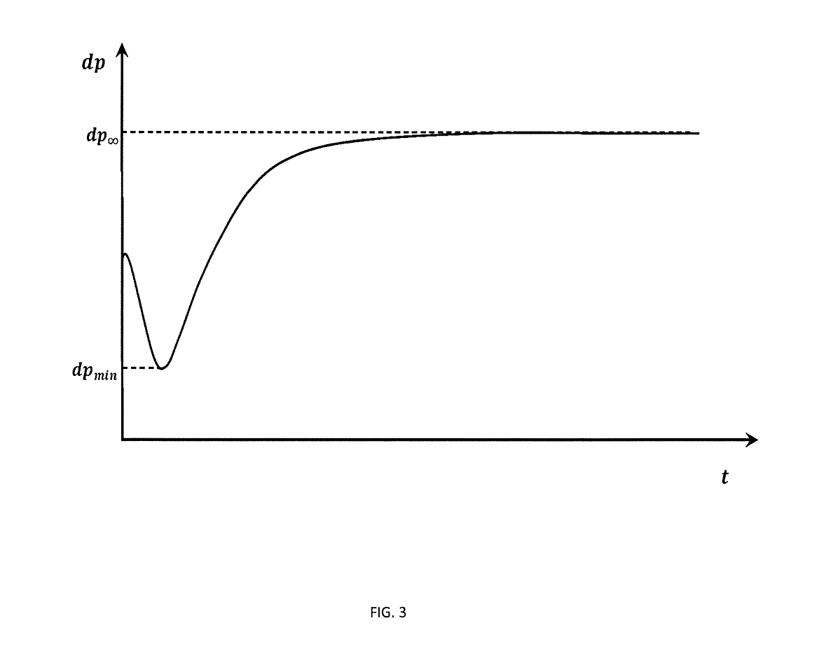

The differential pressure dp is recorded and establishes a curve over time t (see FIG. 3). This curve shows visually an example of the kind of signal trend one would record. The dp decreases initially, then a minimum dpₘᵢₙ becomes apparent as the dp increases, to establish a stabilized dp_{∞}.

Simultaneously as the valves 31 and 32 are closed, a sample of the multiphase fluid which is representative of the liquid components is obtained through one of several possible known methods of sampling live fluids from a flow line 11.

FIG. 3 is a graph describing the transient evolution of the pressure differential reading during the operation of the present disclosure.

The present disclosure provides a densitometer 10 which relies on recording of the differential pressure dp during a period of time. The period of time begins when valves 31 and 32 are closed simultaneously and will last until the differential pressure dp is no longer changing and has achieved a stable value. This evolution of the differential pressure dp takes place while the fluid in the vertical straight cylinder 20 is suddenly isolated from the flowing conditions of the main flow line 11 after the valve closure. Initially the momentum of the upward moving fluid is suddenly obstructed and as a result the differential pressure dp decreases rapidly. It reaches a minimum value dpₘᵢₙ soon thereafter.

This initial transition phase in differential pressure dp variation is caused by a change in momentum of the overall fluid. It is then followed by a second phase in differential pressure dp variation which results from the movement of the free gas within the mixture. It should be noted that, in the case of a two-phase liquid/liquid such as oil and water, the volatile period (i.e. before a stabilized differential pressure dp_{∞} is established) will be much less pronounced than that of FIG. 3. In such a case, the minimum differential pressure dpₘᵢₙ may be a relatively small blip. Once in static state, the fluid which contains a component of free gas will see this component rise through the mixture. As a result, the differential pressure dp will gradually increase and will eventually reach stability in the form of the value dp_{∞}. These two phases in the evolution of the pressure differential dp produces altogether a curve of the signal over a period of time t when the value dp_{∞} is achieved. A typical example of such a curve is shown in FIG. 3.

This disclosure is related to a physical embodiment which includes a means or method to generate the curve as described in FIG. 3, which expresses the transient nature of a differential pressure dp when a multiphase fluid in a dynamic flowing state is entrapped suddenly into an isolation chamber and goes towards a static state. This disclosure describes how phase fractions, or the relative component of each element in the mixture, is calculated using this curve.

The minimum differential pressure dp occurs when the fluid mixture has the maximum gas blended within, before separation, and dpₘᵢₙ can be expressed with the following relationship:

dpₘᵢₙ=ρ_{lg}·H_{T}·g (1)

where dpₘᵢₙ is the minimum value of pressure differential from the differential transmitter 70, ρ_{lg} is the density of the multiphase mixture that is composed of liquid and gas, H_{T} is the distance between the two pressure taps of the pressure differential sensor, also referred to herein as the gauge height, and g is the gravitational acceleration.

It is known that dp_{∞} can be expressed with the following relationship:

dp_{∞}=ρ_{L}·H_{L}·g (2)

where dp_{∞} is the pressure differential value after stabilization, ρ_{L} is the density of the liquid, H_{L} is the liquid level in the cylinder 20, and g is the gravitational acceleration.

In the above relationship, the liquid level H_{L} is unknown.

In an embodiment disclosed, simultaneously as the differential pressure dp curve is recorded, a sample of the fluid is taken and the set aside to be exposed to atmospheric pressure so that the gas component is completely evacuated from the liquid component. This sample, having lost all volatile components, is sometimes referred to as a dead sample, for example a dead oil sample.

Through the vent 62 located at the top of the cylinder, a sufficient quantity of the liquid from the sample is then introduced to fill the cylinder completely. A corresponding differential pressure dp reaches a new value dp_{L} which can be expressed with the following relationship:

dp_{L}=ρ_{L}·H_{T}·g (3)

where, dp_{L} is the pressure differential value when the cylinder 20 is completely filled with liquid, ρ_{L} is the density of liquid, H_{T} is the distance between the two pressure taps of the pressure differential sensor, and g is the gravitational acceleration. This may be solved for liquid density ρ_{L}.

Using the stabilized differential pressure dp_{∞} and the liquid filled differential pressure dp_{L} a ratio coefficient n is provided from the following relationship:

$$\frac{{dp}_{∞}}{{dp}_{L}} = \frac{{H}_{L}}{{H}_{T}} = n \qquad ( 4 )$$

where dp_{∞} is the pressure differential value after stabilization, dp_{L} is the pressure differential value when cylinder is completely filled with liquid, H_{L} is the liquid level in the cylinder, H_{T} is the distance between the two pressure taps of the pressure differential sensor, and n is the ratio coefficient.

From equation (4), the liquid level H_{L} can be expressed as:

H_{L}=n·H_{T} (5)

where H_{L} is the liquid level in the cylinder, and n is the ratio coefficient, and H_{T} is the distance between the two pressure taps of the pressure differential sensor.

Combining equations (3) and (4), dp_{∞} the value of the pressure differential after stabilization (stabilized pressure differential) can be expressed as:

dp_{∞}=ρ_{L}·g·n·H_{T}=dp_{L}·n (6)

where dp_{∞} is the value of the pressure differential after stabilization (stabilized pressure differential), ρ_{L} is the density of liquid, g is the gravitational acceleration, n is the ratio coefficient, H_{T} is the distance between the two pressure taps of the pressure differential sensor, and dp_{L} is the pressure differential value when the cylinder is completely filled with liquid.

Also from equation (4) the pressure differential of the liquid, dp_{L} can be expressed with the value dp_{∞} from the differential pressure transient curve.

$${dp}_{L} = \frac{{dp}_{∞}}{n} \qquad ( 7 )$$

where dp_{L} is the pressure differential value when the cylinder is completely filled with liquid, dp_{∞} is the value of the pressure differential after stabilization (stabilized pressure differential), and n is the ratio coefficient

The liquid level H_{L} can also be determined using other method, such as using ultrasound Doppler readings from the ultrasound Doppler meter 51.

At this stage the problem finds a complete solution. As mentioned above, the Doppler is used to observe the stabilized flow to obtain the stabilized differential pressure dp_{∞} and the liquid level H_{L} can also be measured by the Doppler, providing another route to the solutions.

Liquid Gas Density

The liquid/gas mixture density ρ_{lg} is expressed as:

$${ρ}_{lg} = \frac{{dp}_{min}}{g \cdot {H}_{T}} \qquad ( 8 )$$

where ρ_{lg} is the density of the multiphase mixture that is composed of liquid and gas, dpₘᵢₙ is the minimum value of pressure differential, g is the gravitational acceleration, and H_{T} is the distance between the two pressure taps of the pressure differential sensor 70.

Liquid Density

The liquid mixture density ρₗ is expressed as:

$${ρ}_{L} = \frac{d {p}_{L}}{g \cdot {H}_{T}} = \frac{d {p}_{∞}}{n \cdot g \cdot {H}_{T}} \qquad ( 9 )$$

where ρ_{L} is the density of liquid, dp_{L} is the pressure differential value when the cylinder is completely filled with liquid, H_{T} is the vertical distance between the two pressure taps of the differential pressure sensors, g is the gravitational acceleration, dp_{∞} is the pressure differential value after stabilization, and n is the ratio coefficient.

Gas Density

The gas density ρ_{g} is expressed as:

ρ_{g}=ρₛ·ξₚ·ξ_{T} (10)

where, for an ideal gas:

$${ξ}_{p} = \frac{p + {p}_{a}}{{p}_{s}}$$

and:

$${ξ}_{T} = \frac{{T}_{s} + 273.15}{T + 273.15}$$

where ξₚ is the gas compression/expansion factor, ξ_{T} is the thermal factor, ρₛ is the density of gas at standard conditions, pₐ is the atmospheric (ambient) pressure, p is the absolute operating pressure, pₛ is the standard pressure, T(° C.) is the absolute operating temperature, and Tₛ(° C.) is standard temperature.

Gas Volume Fraction

The Gas Volume Fraction (GVF) may be expressed as:

$$G V F = \frac{{ρ}_{L} - {ρ}_{Lg}}{{ρ}_{L} - {ρ}_{g}} = \frac{\frac{d {p}_{∞}}{n \cdot g \cdot {H}_{T}} - \frac{d {p}_{min}}{g \cdot {H}_{T}}}{\frac{d {p}_{∞}}{n \cdot g \cdot {H}_{T}} - {ρ}_{g}}$$

which may be reduced:

$$G V F = \frac{d {p}_{∞} - d {p}_{min} \cdot n}{d {p}_{∞} - {ρ}_{g} \cdot n \cdot g \cdot {H}_{T}} \qquad ( 11 )$$

where, GVF is the Gas Volume Fraction, p_{lg} is the density of the multiphase mixture that is composed of liquid and gas, ρ_{L} is the density of liquid, dpₘᵢₙ is the minimum value of pressure differential, dp_{L} is the pressure differential value when cylinder is completely filled with liquid, dp_{∞} is the pressure differential value after stabilization, and n is the ratio coefficient.

Water Cut

The Water Cut (WC) is expressed as:

$$W C = \frac{d {p}_{L} - d {p}_{o}}{d {p}_{w} - d {p}_{o}} = \frac{d {p}_{∞} - n \cdot d {p}_{o}}{n \cdot d {p}_{w} - n \cdot d {p}_{o}} \qquad ( 12 )$$

where, WC is the Water cut, dpₒ is the differential pressure reading when the densitometer is filled with pure oil, dp_{w} is the differential pressure reading when the densitometer is filled with pure water, dp_{L} is the pressure differential value when cylinder is completely filled with liquid, dp_{∞} is the pressure differential value after stabilization, and n is the ratio coefficient.

Known Pure Oil Density and Pure Water Density

Alternatively, if the pure oil density p, and pure water density ρ_{w} are known, for example as determined by other means, known to one skilled in the art, and are thus given parameters, then the differential pressure reading when the densitometer is filled with pure oil dpₒ and the differential pressure reading when the densitometer is filled with pure water dp_{w} may be calculated as follows:

dpₒ=ρₒ·g·H_{T}

where dpₒ is the differential pressure reading when the densitometer is filled with pure oil, ρₒ is the known pure oil density, g is the gravitational acceleration, and H_{T} is the is the vertical distance between the two pressure taps of the differential pressure sensors, and:

dp_{w}=ρ_{w}·g·H_{T}

where dp_{w} is the differential pressure reading when the densitometer is filled with pure water, pure water density ρ_{w} is the pure water density, g is the gravitational acceleration, and H_{T} is the vertical distance between the pressure taps.

Example Densitometer Measurements (Without Doppler Liquid Level)

In an example configuration, a densitometer is provided (referring to FIG. 2). Having a H_{T}=300 mm, and L=450 mm.

A multiphase fluid flows through the flow line and upward through the densitometer. The multiphase fluid includes a gas component and a liquid component, the liquid component including a water component and an oil component.

When the valves 31 and 32 are closed, a sample of the multiphase fluid is isolated in the densitometer 10 within the cylinder 20 and the dp monitored. Relatively quickly, a minimum differential pressure dpₘᵢₙ=1.6 kPa is identified; and subsequently a stabilized differential pressure dp_{∞}=2.7 kPa measured.

The dead liquid sample is added back to the densitometer using known methods, such as with a pressurized pumping system, and the differential pressure dp for liquid measured, dp_{L}=2.9 kPa.

In calibrating or proving the densitometer from time to time, when filled with pure water, the differential pressure dp for pure water is measured dp_{w}=2.94 kPa. Similarly, when filled with pure oil, the dp for pure oil is measured dpₒ=2.5 kPa.

Example Densitometer Computations

With the above measurements from the densitometer, one can derive one or more multiphase fluid phase property as follows. In an embodiment, a computer 90 calculates the one or more multiphase fluid property.

A Gas/Liquid Mixture Density may be calculated from:

$${ρ}_{lg} = \frac{d {p}_{min}}{g \cdot {H}_{T}} = \frac{1.6}{9.81 \cdot 0.300} = 0.54 g \text{/} {cm}^{3} \qquad ( 13 )$$

A Ratio Coefficient may be calculated from:

$$n = \frac{d {p}_{∞}}{d {p}_{L}} = \frac{2.7}{2.9} = 0.931 \qquad ( 14 )$$

A Liquid Density may be calculated from:

$${ρ}_{L} = \frac{d {p}_{∞}}{n \cdot g \cdot {H}_{T}} = \frac{2.7}{0.931 \cdot 9.81 \cdot 0.300} = 0.987 g \text{/} {cm}^{3} \qquad ( 15 )$$

A Gas Volume Fraction may be calculated from:

$$G V F = \frac{d {p}_{∞} - d {p}_{min} \cdot n}{d {p}_{∞} - {ρ}_{g} \cdot n \cdot g \cdot {H}_{T}} = \frac{2.7 - 1.6 \cdot 0.931}{2.7 - {ρ}_{g} \cdot 0.931 \cdot 9.81 \cdot 0.300} \qquad ( 16 )$$

which is:

GVF=0.4529 if ρ_{g}=0.01 g/cm³ under pressure of 1 MPa

GVF=0.4988 if ρ_{g}=0.1 g/cm³ under pressure of 10 MPa

A Water Cut may be calculated from:

$$W C = \frac{d {p}_{∞} - n \cdot d {p}_{o}}{n \cdot d {p}_{w} - n \cdot d {p}_{o}} = \frac{2.7 - 0.931 \cdot 2.5}{0.931 \cdot 2.94 - 0.93 \cdot 2.5} = 0.909 \qquad ( 17 )$$

A Pure Oil Density ρₒ may be calculated from:

$${ρ}_{o} = \frac{d {p}_{o}}{g \cdot {H}_{T}} = \frac{2.5}{9.81 * 0.300} = 0.85 g \text{/} {cm}^{3} \qquad ( 18 )$$

A Pure Water Density ρ_{w} may be calculated from:

$${ρ}_{w} = \frac{d {p}_{w}}{g \cdot {H}_{T}} = \frac{2.94}{9.81 * 0.300} = 1.0 g \text{/} {cm}^{3} \qquad ( 19 )$$

Example Densitometer Measurements (with Doppler Liquid Level)

In an embodiment disclosed, the densitometer includes a level transmitter. In an embodiment disclosed, the level transmitter is a Doppler liquid level transmitter which provides a liquid level, H_{L}. In an embodiment disclosed, measuring the liquid level, H_{L} provides another route to determining one or more multiphase flow measurement, or provides another method which can be used comparatively for confirmation.

The differential pressure is measured as above to obtain a dpₘᵢₙ and dp_{∞} but in an embodiment, the liquid level, H_{L} is also measured.

Example Densitometer Computations (with Doppler Liquid Level)

With the liquid level H_{L} from the Doppler, a Ratio Coefficient n may be calculated from:

$$n = \frac{{H}_{L}}{{H}_{T}} = \frac{.2793}{.300} = 0.931 \qquad ( 20 )$$

where n is the ratio coefficient, H_{L} is the liquid level in the cylinder (in this case, provided by the ultrasound Doppler 80, and H_{T} is the distance between the two pressure taps 41, 42 of the pressure differential sensor 70. As can be seen, the Ratio Coefficient n determined with Equation 20 using the Liquid Level H_{L} is the same as the Ratio Coefficient n determined above with Equation 14 using the different technique without the Liquid Level H_{L}. This is also shown in Equation 4.

The Ratio Coefficient, n may then be used to determine a Liquid Density, ρ_{L}, Gas Volume Fraction, GVF, and Water Cut, WC using the same methods above.

A Liquid Density may be calculated:

$${ρ}_{L} = \frac{d {p}_{∞}}{n \cdot g \cdot {H}_{T}} = \frac{2.7}{0.931 \cdot 9.81 \cdot 0.300} = 0.987 g \text{/} {cm}^{3} \qquad ( 21 )$$

which is equivalent to Equation 15, but using the Ratio Coefficient n from Equation 20.

A Gas Volume Fraction may be calculated from:

$$G V F = \frac{d {p}_{∞} - d {p}_{min} \cdot n}{d {p}_{∞} - {ρ}_{g} \cdot n \cdot g \cdot {H}_{T}} = \frac{2.7 - 1.6 \cdot 0.931}{2.7 - {ρ}_{g} \cdot 0.931 \cdot 9.81 \cdot 0.300} \qquad ( 22 )$$

which is equivalent to Equation 16, but using the Ratio Coefficient n from Equation 20, and equals:

GVF=0.4529 if ρ_{g}=0.01 g/cm³ under pressure of 1 MPa

GVF=0.4988 if ρ_{g}=0.1 g/cm³ under pressure of 10 MPa

A Water Cut may be calculated from:

$$W C = \frac{d {p}_{∞} - n \cdot d {p}_{o}}{n \cdot d {p}_{w} - n \cdot d {p}_{o}} = \frac{2.7 - 0.931 \cdot 2.5}{0.931 \cdot 2.94 - 0.93 \cdot 2.5} = 0.909 \qquad ( 23 )$$

which is equivalent to Equation 17, but using the Ratio Coefficient n from Equation 20.

The Gas/Liquid Mixture Density ρ_{lg}, the Pure Oil Density ρₒ, and Pure Water Density ρ_{w}, not relying on the Ratio Coefficient n, are determined as before in Equation 13, Equation 18, and Equation 19 respectively.

In the preceding description, for purposes of explanation, numerous details are set forth in order to provide a thorough understanding of the embodiments. However, it will be apparent to one skilled in the art that these specific details are not required. In other instances, well-known structures and components are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. An inline densitometer for determining one or more phase property of a multiphase fluid in a flow line, comprising:
a vertical chamber adapted to connect to the flow line by an inlet proximate a lower end of the chamber and an outlet proximate an upper end of the chamber, wherein the chamber may be isolated from the flow line by an inlet isolation valve and an outlet isolation valve;
a differential pressure transducer adapted to measure, at frequent intervals or continuously, a differential pressure dp between an upper pressure tap and a lower pressure tap, separated by a gauge height H_{T} to express the transient evolution of the fluids in the chamber to produce a curve adapted to determine a minimum differential pressure dpₘᵢₙ and a stabilized differential pressure dp_{∞};
an ultrasound Doppler level transmitter which signals are used to monitor the transient evolution of the fluids from a dynamic to static state and measure a stabilized liquid level H_{L} in the chamber; and
a computer coupled with the differential pressure transducer and the ultrasound Doppler transmitter to compute the one or more phase property.

2. The densitometer of claim 1, wherein the chamber is a cylinder.

3. The densitometer of claim 1, wherein the differential pressure transducer comprises an inlet pressure transducer to measure an inlet pressure, an outlet pressure transducer to measure an outlet pressure, and the computer is adapted to compute the differential pressure dp by subtracting the outlet pressure from the inlet pressure.

4. The densitometer of claim 1, wherein the one or more phase property comprises a Gas/Liquid Mixture Density, according to the formula:
$${ρ}_{lg} = \frac{d {p}_{min}}{g \cdot {H}_{T}}$$
where ρ_{lg} is the density of the multiphase mixture that is composed of liquid and gas, dpₘᵢₙ is the minimum value of differential pressure, g is the gravitational acceleration, and H_{T} is the distance between the two pressure taps of the pressure differential sensor.

5. The densitometer of claim 1, adapted to determine a Ratio Coefficient n, according to the formula:
$$n = \frac{{H}_{L}}{{H}_{T}}$$
where n is the Ratio Coefficient, H_{L} is the Liquid Level, and H_{T} is the gauge height.

6. The densitometer of claim 1, where the one or more phase property comprises liquid density, according to the formula:
$${ρ}_{L} = \frac{d {p}_{∞}}{g \cdot {H}_{L}}$$
where ρ_{L} is the liquid density, dp_{∞} is the stabilized differential pressure, g is the gravitational acceleration, and H_{L} is the liquid level in the chamber.

7. The densitometer of claim 5, where the one or more phase property comprises liquid density, according to the formula:
$${ρ}_{L} = \frac{d {p}_{∞}}{n \cdot {H}_{T}}$$
where ρ_{L} is the liquid density, dp_{∞} is the stabilized differential pressure, n is the ratio coefficient, and H_{T} is the gauge height.

8. The densitometer of claim 5, where the one or more phase property comprises Gas Volume Fraction, according to:
$$G V F = \frac{d {p}_{∞} - d {p}_{min} \cdot n}{d {p}_{∞} - {ρ}_{g} \cdot n \cdot g \cdot {H}_{T}}$$
where GVF is the Gas Volume Fraction, dpₘᵢₙ is the minimum differential pressure, n is the ratio coefficient, dp_{∞} is the stabilized differential pressure, ρ_{g} is the gas density, g is the gravitational constant, and H_{T} is the gauge height.

9. The densitometer of claim 5, where the one or more phase property comprises Water Cut, according to:
$$W C = \frac{d {p}_{∞} - n \cdot d {p}_{o}}{n \cdot d {p}_{w} - n \cdot d {p}_{o}}$$
where WC is the water cut, dp_{∞} is the stabilized differential pressure, n is the ratio coefficient, dpₒ is the differential pressure value when the chamber is completely filled with pure oil, and dp_{w} differential pressure value when the chamber is completely filled with pure water.

10. A method of determining one or more phase property of a multiphase fluid in a flow line, comprising:
flowing the multiphase fluid upward though a vertical chamber;
capturing a sample, while, at frequent intervals or continuously, monitoring differential pressure dp across the chamber to obtain a minimum differential pressure dpₘᵢₙ and a stabilized differential pressure dp_{∞}, across a gauge height H_{T};
measuring a stabilized liquid level H_{L} in the chamber using a Doppler level transmitter; and
calculating, with a computer, the one or more phase property.

11. The method of claim 10, wherein the one or more phase property comprises a Gas/Liquid Mixture Density ρ_{lg}, according to:
$${ρ}_{lg} = \frac{d {p}_{min}}{g \cdot {H}_{T}}$$
where 92 _{lg} is the density of the multiphase mixture that is composed of liquid and gas, dpₘᵢₙ is the minimum differential pressure, g is the gravitational acceleration, and H_{T} is the gauge height.

12. The method of claim 10, further comprising:
collecting a sample of the multiphase fluid;
allowing gas and any volatile components to evolve from the sample at standard conditions to provide a dead sample;
reintroducing the dead sample into the chamber to fill the chamber to obtain a pressure differential value when the chamber is completely filled with liquid dp_{L}.

13. The method of claim 12, wherein the one or more phase property comprises a liquid density ρ_{L}, according to:
$${ρ}_{L} = \frac{d {p}_{L}}{g \cdot {H}_{T}}$$
where ρ_{L} is the liquid density, dp_{L} is the differential pressure value when the chamber is completely filled with liquid, g is the gravitational acceleration, and H_{T} is the gauge height.

14. The method of claim 12, wherein the one or more phase property comprises a Ratio Coefficient n, according to:
$$n = \frac{d {p}_{∞}}{d {p}_{L}}$$
where n is the ratio coefficient, dp_{∞} is the stabilized differential pressure, and dp_{L} is the differential pressure value when the chamber is completely filled with liquid.

15. The method of claim 14, wherein the one or more phase property comprises a liquid density ρ_{L}, according to the formula:
$${ρ}_{L} = \frac{d {p}_{∞}}{n \cdot g \cdot {H}_{T}}$$
where ρ_{L} is the liquid density, dp_{∞} is the stabilized differential pressure, n is the ratio coefficient, g is the gravitational acceleration, and H_{T} is the gauge height.

16. The method of claim 10, wherein the one or more phase property comprises a Ratio Coefficient n, according to:
$$n = \frac{{H}_{L}}{{H}_{T}}$$
where n is the ratio coefficient, H_{L} is the stabilized liquid level, and H_{T} is the gauge height.

17. The method of claim 16, wherein the one or more phase property comprises a Gas Volume Fraction, according to:
$$G V F = \frac{d {p}_{∞} - d {p}_{min} \cdot n}{d {p}_{∞} - {ρ}_{g} \cdot n \cdot g \cdot {H}_{T}}$$
where GVF is the Gas Volume Fraction, dpₘᵢₙ is the minimum differential pressure, n is the ratio coefficient, dp_{∞} is the stabilized differential pressure, ρ_{g} is the gas density, g is the gravitational constant, and H_{T} is the gauge height.

18. The method of claim 10, further comprising, separate from measuring the multiphase fluid, filling the chamber with a pure oil component of the multiphase fluid to determine a pure oil differential pressure dpₒ.

19. The method of claim 10, further comprising, separate from measuring the multiphase fluid differential pressure, filling the chamber with a pure water component of the multiphase fluid to determine a pure water differential pressure dp_{w}.

20. The method of claim 10, wherein the one or more phase property comprises Water Cut, according to:
$$W C = \frac{d {p}_{∞} - n \cdot d {p}_{o}}{n \cdot d {p}_{w} - n \cdot d {p}_{o}}$$
where WC is the water cut, dp_{∞} is the stabilized differential pressure, n is the ratio coefficient, dpₒ is the pure oil differential pressure, and dp_{w} is the pure water differential pressure.

21. The method of claim 10, the multiphase fluid comprising oil, water, and gas.

22. The method of claim 10, the multiphase fluid comprising gas, gas condensate, and water.

23. The method of claim 10, the multiphase fluid comprising two phases or three phases.

24. Computer readable medium, having stored thereon, computer instructions to perform the method of claim 10.
